(19) United States
(12) Patent Application Publication
(10) Pub. No.: US 2010/0221498 A1
(43) Pub. Date: Sep. 2, 2010

(54) MULTILAYER OBJECT WITH ARIABLE THICKNESS

(76) Inventor: Jacques Thomasset, Vouvry (CH)

Correspondence Address: NIXON & VANDERHYE, PC, 901 NORTH GLEBE ROAD, 11TH FLOOR, ARLINGTON, VA, 22203, US

(21) Appl. No.: 12/676,258

(22) PCT Filed: Aug. 25, 2008
(86) PCT No.: PCT/IB2008/053403

§ 371 Date: Apr. 12, 2010

(30) Foreign Application Priority Data
Sep. 5, 2007 (IB) PCT/IB2007/053573

(51) Int. Cl. B32B 3/26; B32B 27/00

(52) U.S. Cl. 428/172

(57) ABSTRACT

Multilayer article without an axis of symmetry manufactured by compression moulding of a multilayer charge of molten thermoplastic resins, article having a feed centre corresponding to the point around which the charge is centred in the mould before compression, the distance between said feed centre and the edge of the article, known as the flow length, is variable; characterized in that, for a given flow length, the greater the flow length, the smaller the average thickness along this length, and vice versa.

### INCORPORATION FOR REFERENCE

The present invention claims priority based on Application PCT/IB2007/053573, the content of which is fully incorporated into the present application.

### FIELD OF THE INVENTION

The present invention relates to multilayer articles without axial symmetry manufactured from a multilayer charge of molten thermoplastic resin. It also relates to the charges and processes used in relation to these articles.

### PRIOR ART

U.S. Pat. No. 4,876,052, JP2098415 and Patent Applications WO2005087473, WO2005087601, WO2005084904, WO2005084903, WO2005084902 describe multilayer articles and also methods or techniques for manufacturing multilayer articles by compression moulding. These methods consist in compressing a multilayer charge of molten thermoplastic resin in a mould; the compression of said charge resulting in an article that itself also has a multilayer structure. The articles obtained according to these methods have particularly advantageous properties resulting from the multilayer structure that is obtained in the thickness of the article. Thus, such articles may have a reduced permeability to gases, aromas or various chemical substances.

However, the methods described in the prior art can only be used to produce multilayer articles that have an axis of symmetry, that is to say that form an axisymmetric body. These articles have an identical flow length in all directions. Many articles do not have an axis of symmetry and consequently cannot be produced by following the descriptions in the prior art.

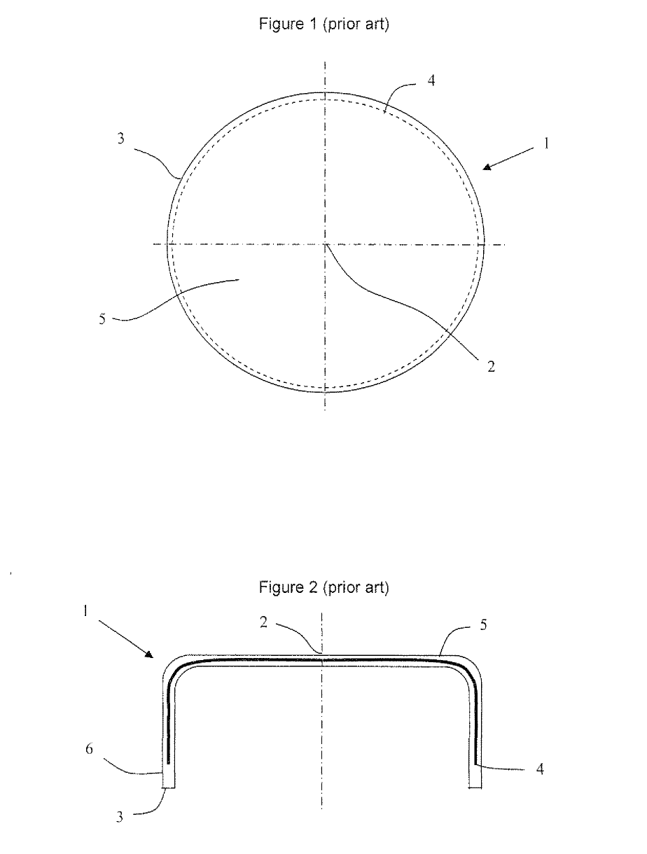

FIGS. 1 and 2 illustrate a multilayer article, the manufacture of which by compression moulding is described in the prior art. FIG. 1 represents the multilayer article as a top view whilst FIG. 2 illustrates the cross section of the article. The multilayer article 1 comprises a feed centre 2 corresponding to the point around which the charge is centred in the mould before compression. For the articles from the prior art, the point 2 corresponds to the intersection between the article 1 and the axis of symmetry. Point 2 is also defined as the centre of flow, that is to say, the point around which the material flows during compression. The edge 3 of the article corresponds to the greatest distance of flow. The multilayer structure has a limit 4 beyond which the thickness of the article is only formed from a single layer. The outline 4 separates the multilayer part 5 from the single-layer part 6 of the article. For the articles from the prior art, the distance between outlines 3 and 4 is constant. Generally, it is desired to reduce the part 6 that has only a single layer.

FIG. 2 displays the cross-sectional view of the article. The multilayer structure forms a part of said article that extends out from the centre of flow to the edge 3. As the article forms an axisymmetric body, the flow is identical in all directions around point 2.

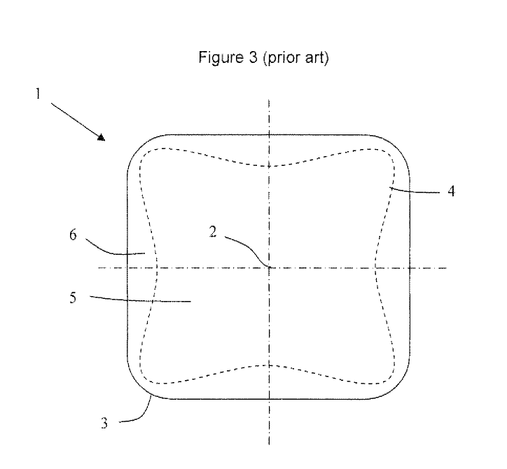

FIG. 3 illustrates an article 1 without an axis of symmetry produced according to known methods. Radial spread of the multilayer structure varies depending on the flow, which is not identical in all the directions around point 2. The multilayer structure has a limit 4 beyond which the thickness of the article is only formed from a single layer. The outline 4 separates the multilayer part 5 from the single-layer part 6 of the article. The distance between the outlines 3 and 4 is not constant; the distribution of the multilayer structure in the article 1 is therefore not optimal.

### SUBJECT OF THE INVENTION

The invention relates to multilayer articles without an axis of symmetry manufactured by compression moulding of a multilayer charge; and also to their method of manufacture. These articles may be, for example, oval tube endpieces, oval stoppers, or rectangular packaging components. The invention allows a better distribution of the multilayer structure, in particular to the edges of the article.

### DESCRIPTION OF THE INVENTION

The invention concerns the production of a multilayer article that does not form an axisymmetric body, the article being manufactured by compression moulding a multilayer charge of molten thermoplastic resin.

The invention relates to an article without an axis of symmetry, moulded by compression of a multilayer charge of resin. This article is characterized by a non-constant thickness that allows an optimum distribution of the multilayer structure in the article.

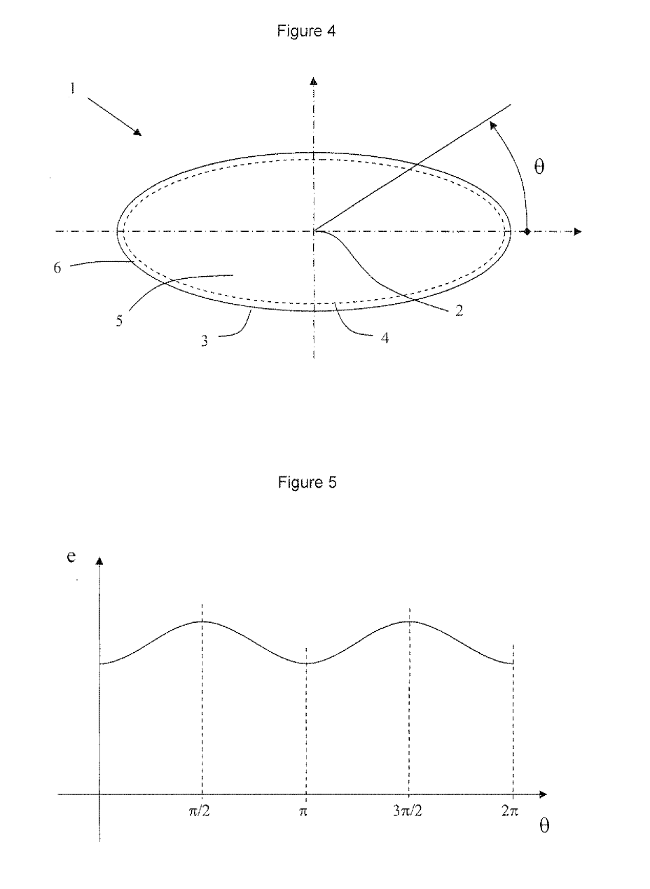

A first embodiment of the invention is illustrated in FIGS. 4 and 5. FIG. 4 represents an article 1 formed from an oval shell of small thickness and delimited by an outline 3. This article is manufactured by compression of a multilayer charge positioned in the cavity of a mould. The charge is centred over the point 2 representing the centre of flow. Due to the thickness profile of the article 1, the multilayer flow is modified and it results in a better distribution of the multilayer structure 5 in the article. The outline 4, delimiting the multilayer structure 5 from the single-layer structure 6, is at a constant distance from the outline 3 that forms the periphery of the article. A controlled distribution of the multilayer structure in the article is obtained owing to the thickness profile.

The thickness profile of the article 1 is represented in FIG. 5. FIG. 5 shows the thickness of the article as a function of the angular position θ, the angle θ being shown in FIG. 4. It has been found, in particular, that the thickness of the article 1 is greater when the curvilinear length between point 2 and the edge 3 is small; and vice versa. There is a relationship between the thickness profile of the article 1 and the distance connecting the centre of flow 2 and the edge 3 of the article.

When the angle θ is equal to π/2 or 3π/2, the curvilinear length between point 2 and the edge 3 is at a minimum, whereas the thickness is at a maximum. Conversely, when the angle θ is equal to 0 or π, the curvilinear length between point 2 and the edge 3 is at a maximum, whereas the thickness is at a minimum.

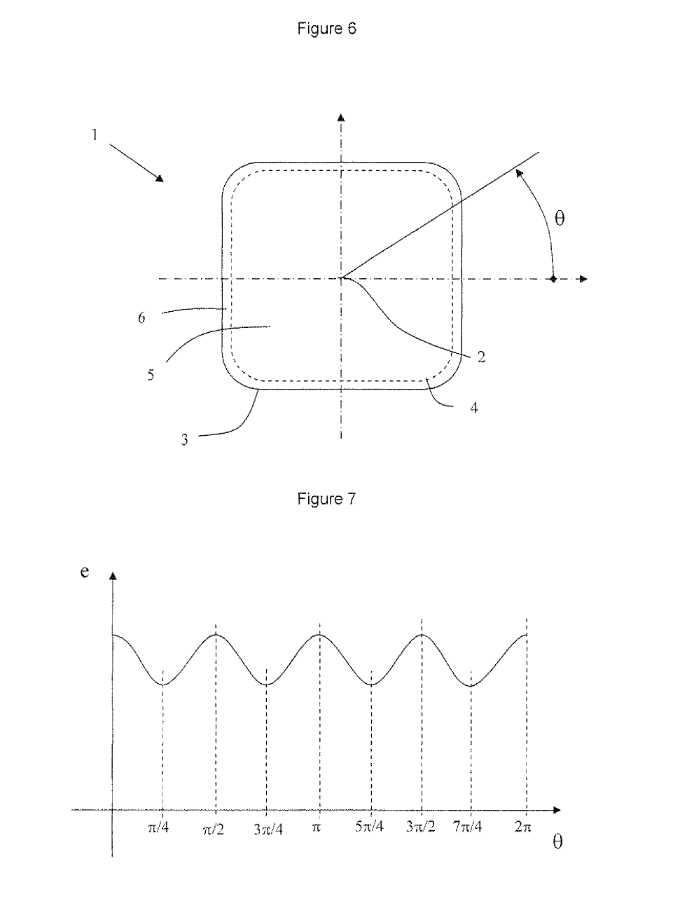

A second embodiment of the invention is illustrated in FIGS. 6 and 7. FIG. 6 represents an article 1 that forms a shell delimited by an outline 3. The shell does not have an axis of symmetry; the distance between the centre of gravity 2 and the outline 3 is not constant. During the manufacture of the article, the multilayer charge is centred over the centre of gravity, which is also the centre of flow 2. The thickness profile of the article is represented in FIG. 7. The thickness depends on the angular position θ shown in FIG. 6. The greater the curvilinear distance (flow length) connecting point 2 to the periphery of the article 3, the smaller the thickness of the article, and vice versa. The thickness profile of the article allows an optimum distribution of the multilayer structure. The distance between the outline 4 formed by the limit of the multilayer structure and the edge 3 is constant over the entire periphery of the article.

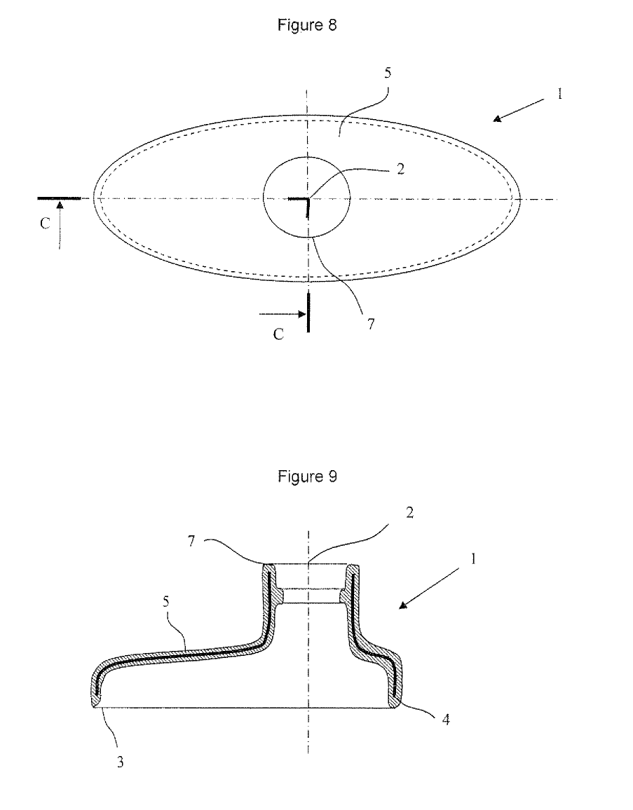

FIG. 8 illustrates a tube shoulder 1 comprising a neck 7. The view of this shoulder along the cross-sectional plane C is illustrated in FIG. 9. FIG. 9 shows that the thickness is not constant over the shoulder. The thickness profile allows an optimum distribution of the multilayer structure. it can be seen that the distance between the limit of the multilayer structure 4 and the periphery 3 of the shoulder is constant over the entire circumference.

As FIG. 9 shows, the variation in thickness may be localized in the article. Thus, the neck of the shoulder is of constant thickness over the entire periphery, whereas the shoulder is of variable thickness. The shoulder illustrated in FIGS. 8 and 9 is particularly interesting because the multilayer structure is distributed homogeneously over the entire article; and the controlled spread of the multilayer structure allows a tube skirt to be welded to the edge 3 of the article.

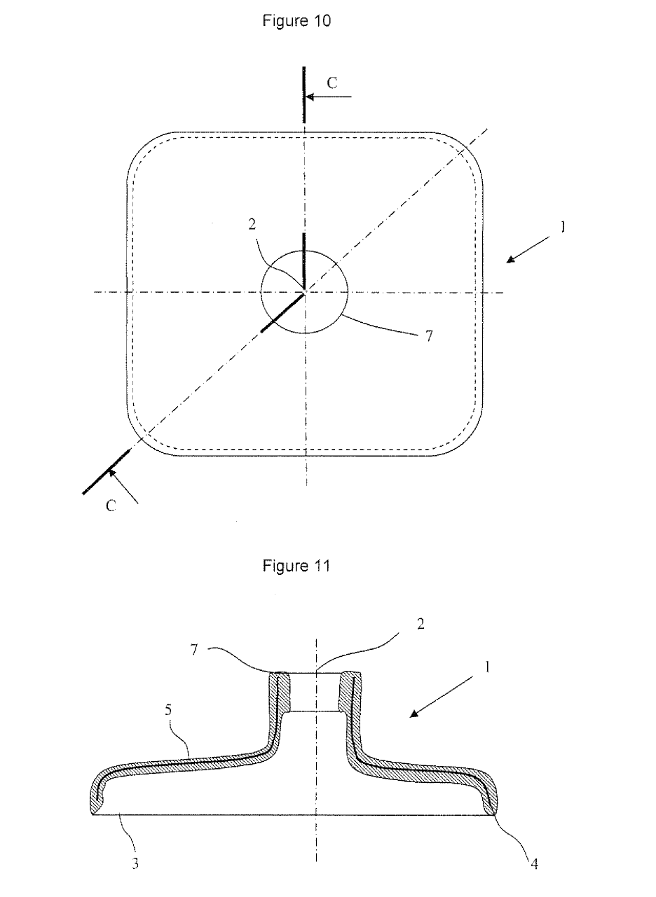

FIGS. 10 and 11 display another exemplary embodiment of the invention. The article 1 represents the neck of a container that is intended to hold liquid products. This container is composed of a neck 1, a tubular body welded to the end 3 of the article 1, and an opening-closing system that makes it possible to seal the orifice 7 when the container is closed. FIG. 10 illustrates the article 1 as a top view. The article 1 does not have an axis of symmetry and forms a rectangular shell comprising an orifice. The thickness profile of the article 1 is illustrated in FIG. 11 which represents the cross-sectional view along C of the article 1.

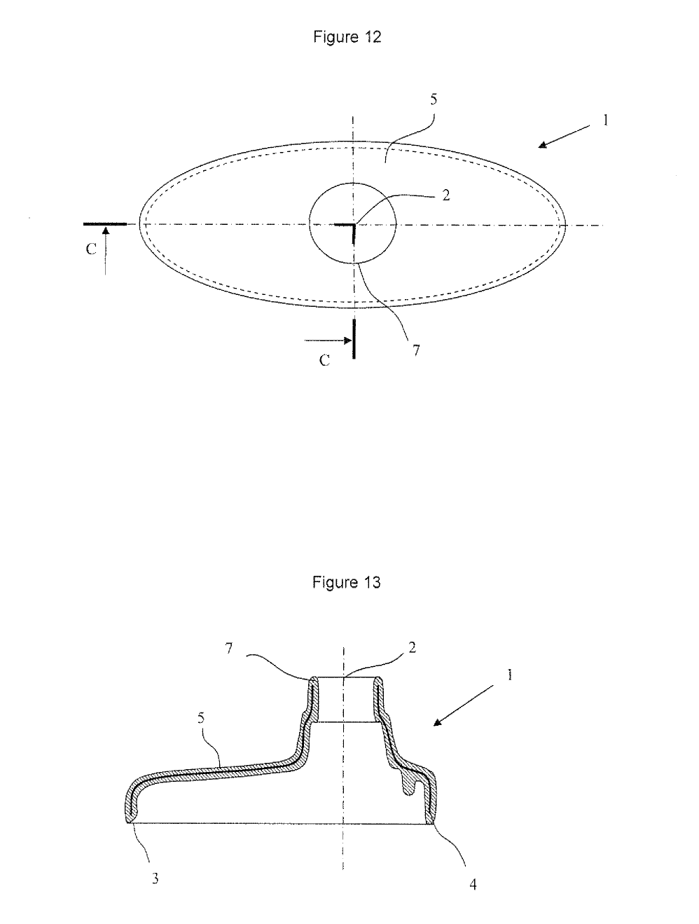

A last example is illustrated in FIGS. 12 and 13. FIG. 12 represents a top view of an oval tube shoulder 1. Its thickness profile is illustrated in FIG. 11, which represents the cross-sectional view along C. This shoulder has the distinctive feature of a local thickness increase that forms a sort of radial rib of variable thickness. Its thickness is at a maximum along the minor axis of the shoulder, that it so say at the location where the curvilinear length connecting the centre of flow 2 to the edge 3 is at a minimum.

The multilayer structures of the articles obtained are of great diversity. For example, the association of a utility resin with a barrier resin makes it possible to improve the impermeability properties of the articles with respect to oxygen or aromas. The following multilayer structures, often used within the packaging field, are particularly advantageous:
PE/adhesive/EVOH/adhesive/PE
PP/adhesive/EVOH/adhesive/PP
PET/PET+oxygen scavengers/adhesive/EVOH/adhesive/PET

where:
PE: polyethylene
PP: polypropylene
PET: polyester terephthalate
EVOH: ethylene vinyl alcohol
Adhesive: polymer used to join several resins

The multilayer charge is preferably axisymmetric, but use may also be made of a charge without an axis of symmetry. However, when the charge does not have an axis of symmetry, an angular orientation of the charge relative to the mould cavity is necessary.

Furthermore, the present invention also makes it possible to obtain multilayer structures that exert a barrier effect with respect to the transmission of electromagnetic waves, in particular in the visible and UV spectra. In these cases, the barrier layer is composed of a thermoplastic resin filled with elements that absorb electromagnetic waves.

Precise positioning of the charge in the mould cavity is necessary to spread the multilayer structure to the end of the article. The charge is normally centred in the mould cavity at the centre of flow, which usually corresponds to the centre of gravity of the article. When it is not necessary to spread the barrier layer to the end of the article, an imprecise centring of the charge in the mould cavity may be accepted.

1. Multilayer article without an axis of symmetry manufactured by compression moulding of a multilayer charge of molten thermoplastic resins, article having a feed centre corresponding to the point around which the charge is centred in the mould before compression, the distance between said feed centre and the edge of the article, known as the flow length, is variable;
characterized in that, for a given flow length, the greater the flow length, the smaller the average thickness along this length, and vice versa.

2. Multilayer article according to claim 1, in which the multilayer structure has a homogeneous distribution.

3. Article according to claim 1, the shape of which is oval.

4. Article according to claim 1, the shape of which is square.

5. Article according to claim 1, the shape of which is rectangular.

6. Article according to claim 1, the shape of which is a tube shoulder.
